(19) United States
(12) Patent Application Publication
(10) Pub. No.: US 2026/0355028 A1
(43) Pub. Date: Nov. 12, 2026

(54) VEHICLE CONTROL APPARATUS, VEHICLE CONTROL METHOD, AND NON-TRANSITORY COMPUTER-READABLE MEDIUM

(71) Applicant: NEC Corporation, Minato-ku, Tokyo (JP)

(72) Inventor: Tomoaki TANAKA, Tokyo (JP)

(73) Assignee: NEC Corporation, Minato-ku, Tokyo (JP)

(21) Appl. No.: 19/123,879

(22) PCT Filed: Nov. 18, 2022
(86) PCT No.: PCT/JP2022/042781

§ 371 Date: Apr. 24, 2025

(51) Int. Cl. A61G 5/02; B60K 35/28; B60W 40/08; B60W 50/14; G05D 1/223; G05D 1/228; G05D 1/246; G05D 1/248; G05D 105/22; G05D 107/13; G05D 109/10; G05D 111/10; G06V 20/58; G06V 20/59; G06V 40/18

(52) U.S. Cl. CPC A61G 5/024; B60K 35/28; B60W 40/08; B60W 50/14; G05D 1/223; G05D 1/228; G05D 1/246; G05D 1/248; G06V 20/58; G06V 20/597; G06V 40/18; A61G 2203/18; A61G 2203/20; B60K 2360/149; B60K 2360/166; B60K 2360/176; B60K 2360/1868; B60W 2050/146; B60W 2420/403; B60W 2540/215; B60W 2540/225; G05D 2105/24; G05D 2107/13; G05D 2109/10; G05D 2111/10

(57) ABSTRACT

Provided are a vehicle control apparatus, a vehicle control method, and a non-transitory computer-readable medium capable of more easily and more reliably moving a vehicle to a destination desired by a user. A vehicle control apparatus includes a first imaging unit that acquires a surrounding image of an electric wheelchair, a display unit that displays the surrounding image, a second imaging unit that acquires a user image, a viewpoint estimation unit that estimates a position of a viewpoint of a user on the surrounding image displayed on the display unit based on the user image, a current position acquisition unit that acquires a current position, a destination estimation unit that estimates a position of a destination corresponding to the viewpoint based on the position of the viewpoint and the current position, and a drive control unit that moves the electric wheelchair to the position of the destination.

### Technical Field

The present disclosure relates to a vehicle control apparatus, a vehicle control method, and a non-transitory computer-readable medium.

### BACKGROUND ART

Wheelchairs are used as transportation means for people with physical disabilities such as elderly people. In addition, electric wheelchairs are used as transportation means for people with reduced arm strength. However, it may be difficult for such people to operate the wheelchairs, for example, in a case where it takes time to make determination and take actions because their reflexes are impaired. Therefore, it is considered that the problem of the operation can be overcome by using automatic control vehicles as transportation means for people with physical disabilities. However, it may be difficult for people with physical disabilities to get on and off the automatic control vehicles, and the automatic control vehicles may be less flexible than wheelchairs.

Therefore, Patent Literature 1 describes a line-of-sight control apparatus that controls an electric wheelchair in a line-of-sight direction of a user. Specifically, the line-of-sight control apparatus according to Patent Literature 1 includes a first camera that images one eye of the user, a second camera that images an area in front of the electric wheelchair, etc., determines a line-of-sight direction based on imaging information imaged by the first camera, and drives the electric wheelchair in the determined line-of-sight direction.

### CITATION LIST

### Patent Literature

Patent Literature 1: Japanese Unexamined Patent Application Publication No. 2011-115460

### SUMMARY OF INVENTION

### Technical Problem

However, in Patent Literature 1, the electric wheelchair is controlled only based on the line-of-sight direction of the user, and a destination desired by the user is not estimated. Therefore, there is a possibility that the user may not be able to reliably move the electric wheelchair to a desired destination.

An example object of the present disclosure is to provide a vehicle control apparatus, a vehicle control method, and a non-transitory computer-readable medium capable of more easily and more reliably moving a vehicle to a destination desired by a user.

### Solution to Problem

A vehicle control apparatus according to a first aspect of the present disclosure includes: a first imaging means for imaging surroundings including at least an area in front of a vehicle; a display means for displaying a surrounding image captured by the first imaging means; a second imaging means for imaging at least a user riding on the vehicle; a viewpoint estimation means for estimating a position of a viewpoint of the user on the surrounding image displayed on the display means based on the user image captured by the second imaging means; a current position acquisition means for acquiring a current position of the vehicle; a destination estimation means for estimating a position of a destination corresponding to the viewpoint based on at least the position of the viewpoint and the current position of the vehicle in a case where the viewpoint is at the same location on the surrounding image for a predetermined time; and a drive control means for moving the vehicle to the position of the destination.

A vehicle control method according to a second aspect of the present disclosure is a method performed by a computer, the vehicle control method including: causing a first imaging means to image surroundings including at least an area in front of a vehicle; causing a display means to display a surrounding image captured by the first imaging means; causing a second imaging means to image at least a user riding on the vehicle; estimating a position of a viewpoint of the user on the surrounding image displayed on the display means based on the user image captured by the second imaging means; acquiring a current position of the vehicle; estimating a position of a destination corresponding to the viewpoint based on at least the position of the viewpoint and the current position of the vehicle in a case where the viewpoint is at the same location on the surrounding image for a predetermined time; and moving the vehicle to the position of the destination.

A non-transitory computer-readable medium according to a third aspect of the present disclosure stores a program that causes a computer to execute: causing a first imaging means to image surroundings including at least an area in front of a vehicle; causing a display means to display a surrounding image captured by the first imaging means; causing a second imaging means to image at least a user riding on the vehicle; estimating a position of a viewpoint of the user on the surrounding image displayed on the display means based on the user image captured by the second imaging means; acquiring a current position of the vehicle; estimating a position of a destination corresponding to the viewpoint based on at least the position of the viewpoint and the current position of the vehicle in a case where the viewpoint is at the same location on the surrounding image for a predetermined time; and moving the vehicle to the position of the destination.

### Advantageous Effects of Invention

It is possible to provide a vehicle control apparatus, a vehicle control method, and a non-transitory computer-readable medium capable of more easily and more reliably moving a vehicle to a destination desired by a user.

### BRIEF DESCRIPTION OF DRAWINGS

FIG. 1 is a block diagram illustrating an example of a vehicle control apparatus according to a first example embodiment.

FIG. 2 is a diagram illustrating an example of an environment surrounding a user riding on a wheelchair.

FIG. 3 is a diagram illustrating an example of a surrounding image displayed on a display unit according to the first example embodiment.

FIG. 4 is a flowchart illustrating an example of a vehicle control method according to the first example embodiment.

FIG. 5 is a block diagram illustrating an example of a vehicle control apparatus according to a second example embodiment.

FIG. 6 is a diagram illustrating an example of a surrounding image displayed on a display unit according to the second example embodiment.

FIG. 7 is a flowchart illustrating an example of a vehicle control method according to the second example embodiment.

FIG. 8 is a block diagram illustrating an example of a vehicle control apparatus according to a third example embodiment.

FIG. 9 is a diagram illustrating an example of a surrounding image displayed on a display unit according to the third example embodiment.

FIG. 10 is a flowchart illustrating an example of a vehicle control method according to the third example embodiment.

FIG. 11 is a block diagram illustrating an example of a vehicle control apparatus according to a fourth example embodiment.

FIG. 12 is a diagram illustrating an example of a surrounding image displayed on a display unit according to the fourth example embodiment.

FIG. 13 is a diagram illustrating an example of map information around a wheelchair on which a user is riding.

FIG. 14 is a diagram illustrating an example of a surrounding image and a list of candidate destinations displayed on a display unit according to the fourth example embodiment.

FIG. 15 is a flowchart illustrating an example of a vehicle control method according to the fourth example embodiment.

### EXAMPLE EMBODIMENT

Example embodiments of the present disclosure will be described below with reference to the drawings.

### First Example Embodiment

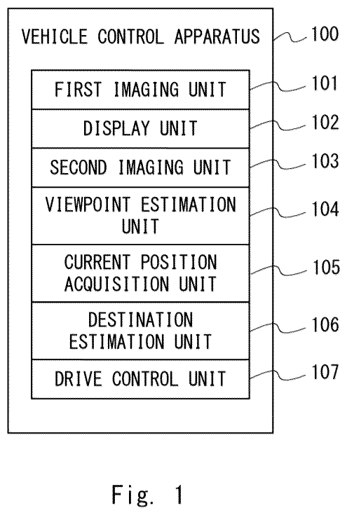

FIG. 1 is a block diagram illustrating an example of a vehicle control apparatus 100 according to a first example embodiment. The vehicle control apparatus 100 controls an operation of a vehicle, e.g., an electric wheelchair. Furthermore, the vehicle control apparatus 100 controls the operation of the vehicle based on a line of sight of a user riding on the vehicle. Hereinafter, an electric wheelchair will be described as an example of the vehicle, but an object controlled by the vehicle control apparatus 100 is not limited to the electric wheelchair, and may be any moving object on which a user can ride. For example, the object controlled by the vehicle control apparatus 100 may be a passenger car, personal mobility, or the like.

As illustrated in FIG. 1, the vehicle control apparatus 100 includes a first imaging unit 101, a display unit 102, a second imaging unit 103, a viewpoint estimation unit 104, a current position acquisition unit 105, a destination estimation unit 106, and a drive control unit 107.

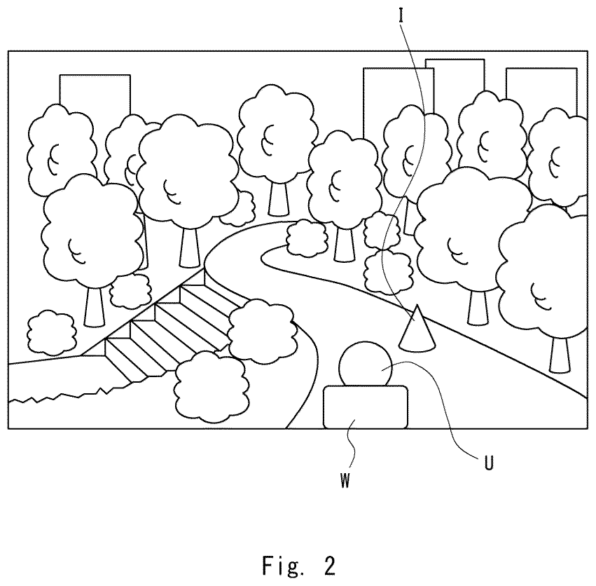

The first imaging unit 101 is also referred to as a first imaging means. The first imaging unit 101 is a camera or the like, and acquires a surrounding image by imaging surroundings including at least an area in front of an electric wheelchair W. FIG. 2 illustrates an example of an environment surrounding a user U riding on the electric wheelchair W. FIG. 2 illustrates surroundings in front of the electric wheelchair W as viewed from behind the user U riding on the electric wheelchair W. The first imaging unit 101 images at least an area in front of the user U riding on the electric wheelchair W, out of the surrounding environment. Note that the first imaging unit 101 may image two or more of areas in front of, besides, behind, and above the user U riding on the electric wheelchair W. Furthermore, the image acquired by the first imaging unit 101 is, for example, a two-dimensional image, and may be a two-dimensional RGB image. Furthermore, the first imaging unit 101 may be an infrared camera.

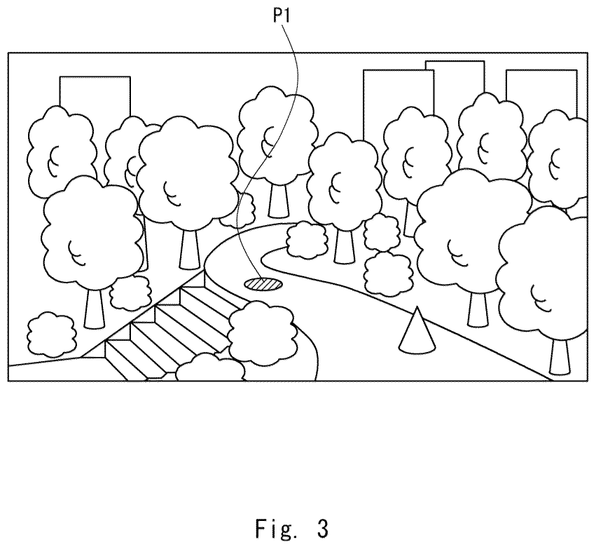

The display unit 102 is also referred to as a display means. The display unit 102 is a display such as a liquid crystal display (LCD) or a light emitting diode (LED), and displays a surrounding image captured by the first imaging unit 101. FIG. 3 illustrates an example of the surrounding image displayed on the display unit 102. The display unit 102 is installed at a position where the user U riding on the electric wheelchair W can visually recognize the surrounding image displayed on the display unit 102.

The second imaging unit 103 is also referred to as a second imaging means. The second imaging unit 103 is a camera or the like, and acquire a user image by capturing at least the user U riding on the electric wheelchair W. Specifically, the second imaging unit 103 images an area including the eyes of the user U. The user image is, for example, a two-dimensional image, and may be a two-dimensional RGB image. Furthermore, the second imaging unit 103 may be an infrared camera.

The viewpoint estimation unit 104 is also referred to as a viewpoint estimation means. The viewpoint estimation unit 104 estimates a position of a viewpoint of the user U on the surrounding image displayed on the display unit 102 based on the user image captured by the second imaging unit 103. In the surrounding image illustrated in FIG. 3, the viewpoint estimated by the viewpoint estimation unit 104 is indicated as a viewpoint P1. The viewpoint estimation unit 104 estimates a line-of-sight direction of the user U from the user image by a known method described in, for example, International Patent Publication No. WO2014/084224, International Patent Publication No. WO2020/054855, etc., and estimates a position of the viewpoint Pl of the user U on the surrounding image based on the estimated line-of-sight direction. Here, the position of the viewpoint Pl is expressed by image coordinates in the surrounding image. Here, the image coordinates are coordinates for indicating a position of a pixel on the two-dimensional image, and are, for example, coordinates with the center of the pixel located on the leftmost and uppermost side of the two-dimensional image as the origin, the left-right direction or the horizontal direction being defined as an x direction, and the up-down direction or the vertical direction being defined as a y direction.

In a case where the viewpoint P1 is at the same location on the surrounding image for a predetermined time, the viewpoint estimation unit 104 outputs the position (image coordinates) of the viewpoint P1 to the destination estimation unit 106. In a case where the viewpoint P1 is not on the surrounding image, that is, in a case where the viewpoint P1 is outside the display unit 102, the viewpoint estimation unit 104 cannot estimate the position (image coordinates) of the viewpoint P1, and thus does not output the position of the viewpoint P1 to the destination estimation unit 106.

The current position acquisition unit 105 is also referred to as a current position acquisition means. The current position acquisition unit 105 is a GPS receiver, a quasi-zenith satellite system (QZSS) compatible receiver, or the like, and acquires a current position of the electric wheelchair W. Here, the current position is a position in a world coordinate system representing the real world, and is expressed by, for example, a latitude and a longitude, but is not limited thereto. Note that, in the following description of the present specification, the current position is expressed by a latitude and a longitude.

The destination estimation unit 106 is also referred to as a destination estimation means. The destination estimation unit 106 estimates a position of the destination corresponding to the viewpoint Pl based on the position of the viewpoint Pl estimated by the viewpoint estimation unit 104, the current position of the electric wheelchair W, the angle of view and the specifications of the imaging sensor (not illustrated) provided in the first imaging unit 101, and the posture of the electric wheelchair W. Here, the position of the destination is expressed by a latitude and a longitude. The specifications are internal parameters. In addition, the posture of the electric wheelchair W is an angle and a direction of the electric wheelchair W detected based on signals output from a gyro sensor, an acceleration sensor, and the like provided in the electric wheelchair W. In addition, the first imaging unit 101 may also include a gyro sensor, an acceleration sensor, and the like, and the posture of the electric wheelchair W may include an angle and a direction of the first imaging unit 101. Here, the “direction” refers to a direction (azimuth) on a horizontal plane such as east, west, north, or south. Further, the “angle” is, for example, an angle at which the electric wheelchair W is inclined with respect to the vertical direction.

Specifically, the destination estimation unit 106 estimates a distance and a direction from the imaging sensor to the object present around the electric wheelchair W and corresponding to the viewpoint P1, by a known method, based on the position (image coordinates) of the viewpoint P1 on the surrounding image and the angle of view and the specifications of the imaging sensor (not illustrated). Here, in the example illustrated in FIG. 3, the object is a place on the road pointed to by the viewpoint P1. Then, the destination estimation unit 106 estimates a position (latitude and longitude) of the object corresponding to the viewpoint P1 on the surrounding image as the position of the destination based on the current position (latitude and longitude) of the electric wheelchair W and the estimated distance and direction.

In a case where the viewpoint P1 of the user U is not on the road in the surrounding image, the destination estimation unit 106 may not estimate a position of the destination. Furthermore, in a case where the viewpoint P1 of the user U is at a place other than the road in the surrounding image, for example, in a case where the viewpoint P1 of the user U is at a tree in the surrounding image, the position of the tree on the ground may be set as the position (image coordinates) of P1. In this case, an object in the surrounding image may be recognized using image recognition in the surrounding image. In addition, a road in the surrounding image may be detected in advance using image recognition in the surrounding image, and the display unit 102 may display only the detected road. The destination estimation unit 106 may perform destination estimation only in a case where the viewpoint P1 is on the displayed road.

The drive control unit 107 is also referred to as a drive control means. The drive control unit 107 automatically moves the electric wheelchair W to the position of the destination. Specifically, the drive control unit 107 performs obstacle detection and the like by a known method, calculates a route from the current position of the electric wheelchair W to the position of the destination, and controls the operation of the electric wheelchair W so that the electric wheelchair W moves along the route. For example, in the surrounding environment illustrated in FIG. 2, the drive control unit 107 detects an obstacle I using a sensor such as an infrared sensor, and moves the electric wheelchair W to the destination while avoiding the obstacle I.

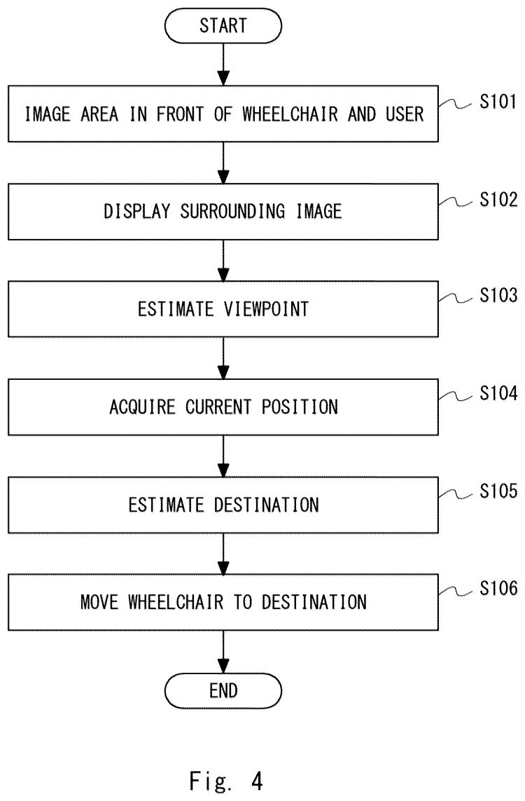

Next, a vehicle control method according to the first example embodiment will be described with reference to FIG. 4. First, the first imaging unit 101 images an area in front of the electric wheelchair W, and the second imaging unit 103 images the user U (step S101). In addition, the first imaging unit 101 outputs the acquired surrounding image to the display unit 102, and the second imaging unit 103 outputs the acquired user image to the viewpoint estimation unit 104.

Next, the display unit 102 displays the surrounding image captured by the first imaging unit 101 (step S102). As a result, the user U riding on the electric wheelchair W can visually recognize the surrounding image.

Next, the viewpoint estimation unit 104 estimates a position (image coordinates) of the viewpoint P1 of the user U on the surrounding image displayed on the display unit 102, based on the user image captured by the second imaging unit 103 (step S103). In a case where the viewpoint P1 is at the same location on the surrounding image for a predetermined time, the viewpoint estimation unit 104 outputs the position (image coordinates) of the viewpoint P1 to the destination estimation unit 106. In addition, in a case where the viewpoint P1 is outside the display unit 102, the viewpoint estimation unit 104 cannot estimate image coordinates representing the position of the viewpoint P1, and in this case, the destination estimation processing of step S105 in the subsequent stage is not executed. Therefore, in a case where the electric wheelchair W is already stopped, the electric wheelchair W remains stopped, and in a case where the electric wheelchair W is moving in a predetermined manner, the electric wheelchair W continues to move in that manner.

Next, the current position acquisition unit 105 acquires a current position (latitude and longitude) of the electric wheelchair W (step S104). In addition, the current position acquisition unit 105 outputs the current position (latitude and longitude) to the destination estimation unit 106.

Next, the destination estimation unit 106 estimates a position (latitude and longitude) of the destination corresponding to the viewpoint P1, based on the position of the viewpoint P1, the current position of the electric wheelchair W, the angle of view and the specifications of the imaging sensor (not illustrated) provided in the first imaging unit 101, and the posture of the electric wheelchair W (step S105).

Next, the drive control unit 107 automatically moves the electric wheelchair W to the position of the destination (step S106), and ends this processing.

The vehicle control apparatus 100 according to the first example embodiment described above estimates a destination desired by the user U, and automatically moves the electric wheelchair W to the destination. Therefore, it is possible to more reliably move the electric wheelchair W to the destination desired by the user U, as compared with a case where the electric wheelchair W is controlled only based on a line-of-sight direction. Furthermore, the vehicle control apparatus 100 according to the first example embodiment estimates the viewpoint P1 of the user U on the surrounding image displayed by the display unit 102, and estimates the position of the destination corresponding to the viewpoint P1. As a result, even in a case where the user U has difficulty in operating the wheelchair, it is possible to operate the electric wheelchair W only by adjusting the viewpoint P1 to a desired destination on the surrounding image for a predetermined time. Therefore, it is possible to more easily and more reliably move the electric wheelchair W to the destination desired by the user U.

Note that the vehicle control apparatus 100 includes a processor, a memory, and a storage device as components not illustrated. In addition, the storage device stores a computer program in which the processing of the vehicle control method according to the present example embodiment is implemented. Then, the processor reads the computer program from the storage device into the memory and executes the computer program. As a result, the processor realizes the functions of the viewpoint estimation unit 104, the current position acquisition unit 105, the destination estimation unit 106, and the drive control unit 107.

Alternatively, each of the viewpoint estimation unit 104, the current position acquisition unit 105, the destination estimation unit 106, and the drive control unit 107 may be realized by dedicated hardware. In addition, some or all of the components of each apparatus may be realized by general-purpose or dedicated circuitry, a processor, or a combination thereof. These components may be configured by a single chip, or may be configured by a plurality of chips connected to each other via a bus. Some or all of the components of each apparatus may be realized by a combination of the above-described circuit or the like and a program. Furthermore, as the processor, a central processing unit (CPU), a graphics processing unit (GPU), a field-programmable gate array (FPGA), or the like may be used.

### Second Example Embodiment

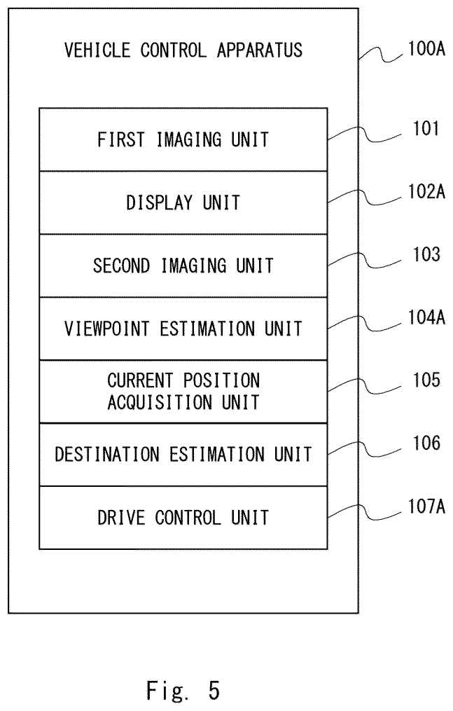

Next, a vehicle control apparatus 100A according to the second example embodiment will be described. FIG. 5 is a block diagram illustrating an example of the vehicle control apparatus 100A according to the second example embodiment. The vehicle control apparatus 100A is different from the vehicle control apparatus 100 according to the first example embodiment in a display unit 102A, a viewpoint estimation unit 104A, and a drive control unit 107A. Therefore, among the components of the vehicle control apparatus 100A, components similar to those of the vehicle control apparatus 100 are denoted by the same reference numerals, and description thereof will be omitted.

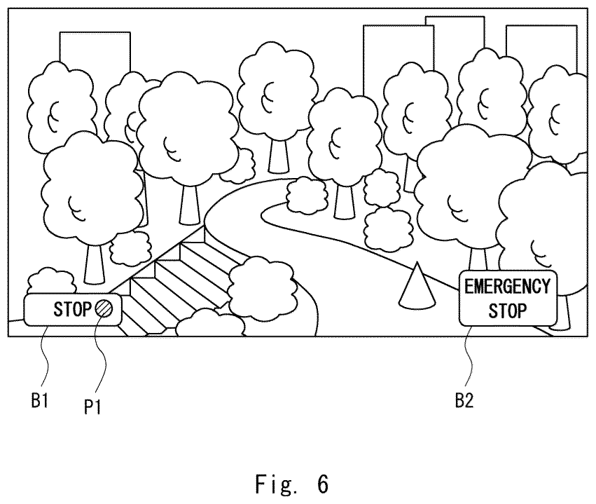

The display unit 102A displays a stop mark and an emergency stop mark together with the surrounding image. The stop mark is a display indicating a stop operation, and is, for example, a button or an icon indicating a stop operation. Similarly, the emergency stop mark is a display indicating an emergency stop operation, and is, for example, a button or an icon indicating an emergency stop operation. For example, as illustrated in FIG. 6, the display unit 102A displays a stop mark Bl and an emergency stop mark B2 superimposed on the surrounding image. More specifically, the display unit 102A displays the stop mark B1 and the emergency stop mark B2 only in a case where the electric wheelchair W is moving. Note that positions (image coordinates) at which the stop mark B1 and the emergency stop mark B2 are superimposed on the surrounding image are determined in advance. Furthermore, the display unit 102A may display only one of the stop mark B1 and the emergency stop mark B2 superimposed on the surrounding image. In addition, the display unit 102A may display the stop mark B1 and the emergency stop mark B2 even in a case where the electric wheelchair W is not moving.

The viewpoint estimation unit 104A determines whether the viewpoint P1 is at the stop mark B1 or the emergency stop mark B2 for a predetermined time on the surrounding image. Then, in a case where the viewpoint P1 is at the stop mark B1 or the emergency stop mark B2 on the surrounding image for the predetermined time, the viewpoint estimation unit 104A outputs a stop command or an emergency stop command to the drive control unit 107A. Note that processing in a case where the viewpoint P1 is at a place other than the stop mark B1 or the emergency stop mark B2 on the surrounding image for the predetermined time is similar to that of the viewpoint estimation unit 104 according to the first example embodiment, and thus description thereof will be omitted.

In a case where the viewpoint P1 is at the stop mark B1 for the predetermined time on the surrounding image, the drive control unit 107A stops the electric wheelchair W. Specifically, in a case where a stop command is input from the viewpoint estimation unit 104A, the drive control unit 107A gently stops the electric wheelchair.

In addition, in a case where the viewpoint P1 is at the emergency stop mark B2 on the surrounding image for the predetermined time, the drive control unit 107A urgently stops the electric wheelchair W. Specifically, in a case where an emergency stop command is input from the viewpoint estimation unit 104A, the drive control unit 107A urgently stops the electric wheelchair.

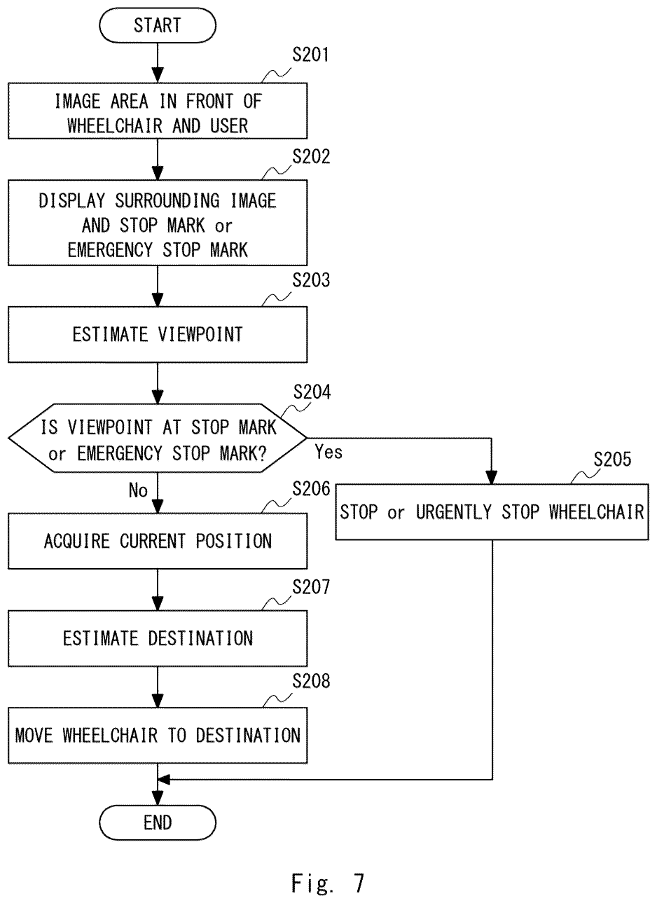

Next, a vehicle control method according to the second example embodiment will be described with reference to FIG. 7. Note that processing of step S201, step S203, and steps S206 to S208 in the vehicle control method according to the second example embodiment is similar to the processing of step S101, step S103, and steps S104 to S106 in the vehicle control method according to the first example embodiment, respectively, and thus description thereof will be omitted.

The display unit 102A displays the surrounding image, and displays the stop mark B1 and the emergency stop mark B2 only in a case where the electric wheelchair W is moving (step S202). As a result, the user U riding on the electric wheelchair W can visually recognize the surrounding image, the stop mark B1, and the emergency stop mark B2.

The viewpoint estimation unit 104A determines whether the viewpoint P1 is at the stop mark B1 or the emergency stop mark B2 on the surrounding image displayed on the display unit 102A for a predetermined time (step S204).

In step S204, in a case where the viewpoint P1 is at a place other than the stop mark Bl or the emergency stop mark B2 on the surrounding image for the predetermined time (step S204; No), the processing proceeds to step S206.

In step S204, in a case where the viewpoint Pl is at the stop mark B1 or the emergency stop mark B2 on the surrounding image for the predetermined time (step S204; Yes), the viewpoint estimation unit 104A outputs a stop command or an emergency stop command to the drive control unit 107A. Then, the drive control unit 107A stops or urgently stops the electric wheelchair W (step S205), and ends this processing.

The vehicle control apparatus 100A according to the second example embodiment described above enables the user U to stop the electric wheelchair W only by looking at the stop mark B1 on the surrounding image. In addition, the user U is enabled to urgently stop the electric wheelchair W only by looking at the emergency stop mark B2 on the surrounding image. As a result, the user U can use the electric wheelchair W more easily and more safely.

### Modified Example

Note that the display unit 102A of the vehicle control apparatus 100A according to the second example embodiment may display marks for other controls of the vehicle. For example, the display unit 102A may display marks indicating a direction change control, a door opening control, and a door closing control of the electric wheelchair W. Then, in a case where the viewpoint estimation unit 104A determines that the viewpoint P1 of the user U is at any of these marks for the predetermined time, the drive control unit 107A may change the direction of the electric wheelchair W or open or close the door of the electric wheelchair W. In addition, the display unit 102A may display marks indicating a music or video reproduction-related operation and an air conditioning operation. Then, in a case where the viewpoint estimation unit 104A determines that the viewpoint P1 of the user U is at any of these marks for the predetermined time, the electric wheelchair W may reproduce music or video and control air conditioning.

### Third Example Embodiment

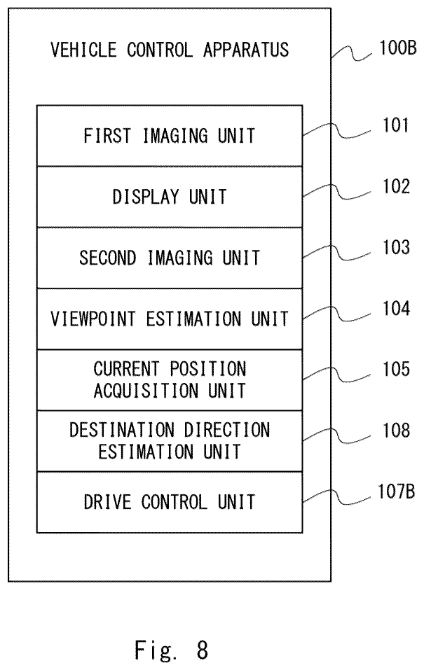

Next, a vehicle control apparatus 100B according to the third example embodiment will be described. FIG. 8 is a block diagram illustrating an example of the vehicle control apparatus 100B according to the third example embodiment. The vehicle control apparatus 100B includes a destination direction estimation unit 108 instead of the destination estimation unit 106, and is different from the vehicle control apparatus 100 according to the first example embodiment in a drive control unit 107B. Therefore, among the components of the vehicle control apparatus 100B, components similar to those of the vehicle control apparatus 100 are denoted by the same reference numerals, and description thereof will be omitted.

The destination direction estimation unit 108 is also referred to as a destination direction estimation means. The destination direction estimation unit 108 estimates a destination direction corresponding to the line-of-sight direction estimated by the viewpoint estimation unit 104. Here, the destination direction is a direction desired by the user U, and refers to a direction in which the electric wheelchair W is moved. Furthermore, as described in the first example embodiment, the viewpoint estimation unit 104 estimates a line-of-sight direction of the user U from the user image by a known method.

Specifically, in a case where the line-of-sight direction estimated by the viewpoint estimation unit 104 is the same direction for a predetermined time, the destination direction estimation unit 108 estimates a destination direction corresponding to the line-of-sight direction.

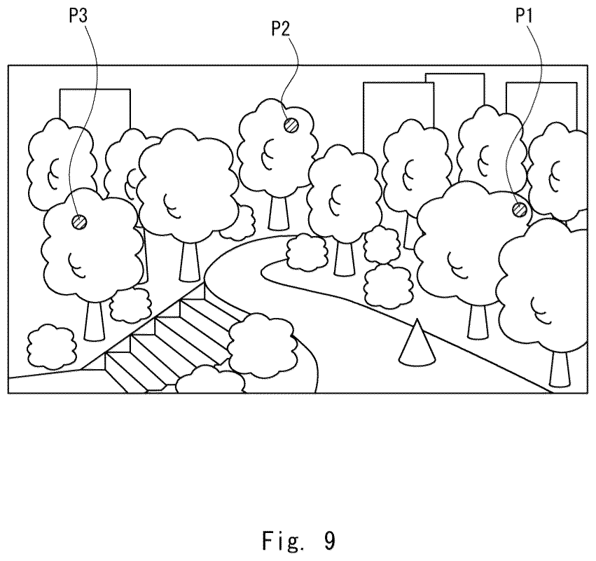

The estimation of the destination direction by the destination direction estimation unit 108 will be described more specifically with reference to FIG. 9. A case where the viewpoint of the user U is, for example, any of the viewpoints P1, P2, and P3 in the surrounding image displayed on the display unit 102 illustrated in FIG. 9 will be considered. Note that the user U riding on the electric wheelchair W is present at the center in front of the surrounding image. Therefore, in a case where the viewpoint estimation unit 104 estimates that the position of the viewpoint of the user U is, for example, at the viewpoint P1 in the surrounding image displayed on the display unit 102 illustrated in FIG. 9, the destination direction estimation unit 108 estimates the destination direction to be diagonally forward to the right. Similarly, in a case where the viewpoint estimation unit 104 estimates that the position of the viewpoint of the user U is, for example, at the viewpoint P2 in the surrounding image displayed on the display unit 102 illustrated in FIG. 9, the destination direction estimation unit 108 estimates the destination direction to be forward at the center. In addition, in a case where the viewpoint estimation unit 104 estimates that the position of the viewpoint of the user U is, for example, at the viewpoint P3 in the surrounding image displayed on the display unit 102 illustrated in FIG. 9, the destination direction estimation unit 108 estimates the destination direction to be diagonally forward to the left.

The drive control unit 107B moves the electric wheelchair W in the destination direction estimated by the destination direction estimation unit 108. Note that the stop mark B1, the emergency stop mark B2, and the like described in the second example embodiment may be displayed on the display unit 102. In a case where the viewpoint P1 of the user U is at the stop mark B1 or the emergency stop mark B2 for a predetermined time, the drive control unit 107B may stop or emergently stop the electric wheelchair W.

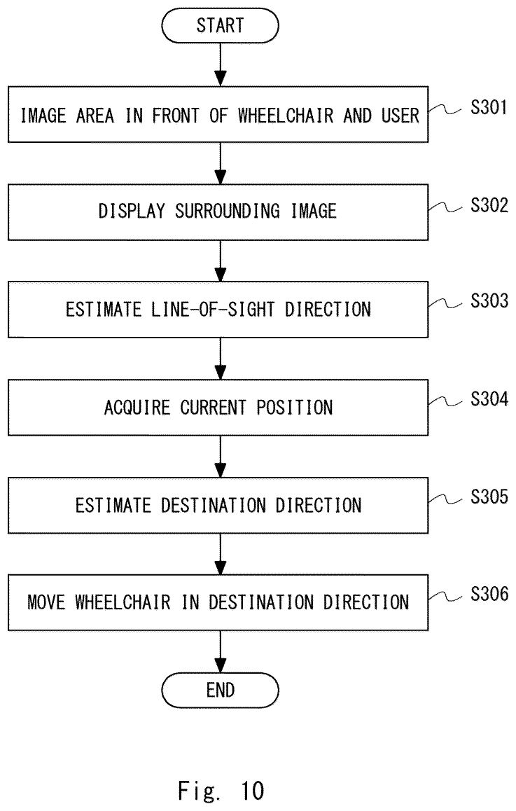

Next, a vehicle control method according to the third example embodiment will be described with reference to FIG. 10. Note that processing of step S301, step S302, and step S304 in the vehicle control method according to the third example embodiment is similar to the processing of step S101, step S102, and step S104 in the vehicle control method according to the first example embodiment, respectively, and thus description thereof will be omitted.

The viewpoint estimation unit 104 estimates a line-of-sight direction of the user U from the user image (step S303). In addition, the viewpoint estimation unit 104 outputs the estimated line-of-sight direction to the destination direction estimation unit 108.

The destination direction estimation unit 108 estimates a destination direction corresponding to the line-of-sight direction estimated by the viewpoint estimation unit 104 (step S305). In addition, the destination direction estimation unit 108 outputs the estimated destination direction to the drive control unit 107B.

The drive control unit 107B moves the electric wheelchair W in the destination direction (step S306), and ends this processing.

The vehicle control apparatus 100B according to the third example embodiment described above enables the user U to move the electric wheelchair W in a desired direction only by looking at the desired direction on the surrounding image. As a result, the user U can use the electric wheelchair W more easily.

### Fourth Example Embodiment

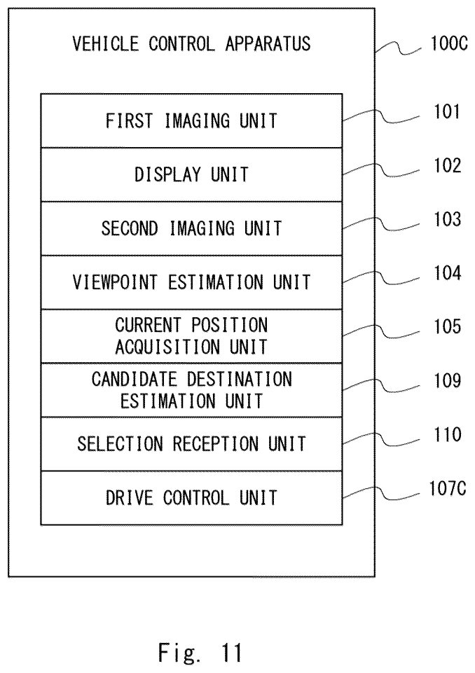

Next, a vehicle control apparatus 100C according to the fourth example embodiment will be described. FIG. 11 is a block diagram illustrating an example of the vehicle control apparatus 100C according to the fourth example embodiment. The vehicle control apparatus 100C includes a candidate destination estimation unit 109 and a selection reception unit 110 instead of the destination estimation unit 106, and is different from the vehicle control apparatus 100 according to the first example embodiment in a drive control unit 107C. Therefore, among the components of the vehicle control apparatus 100C, components similar to those of the vehicle control apparatus 100 are denoted by the same reference numerals, and description thereof will be omitted.

The candidate destination estimation unit 109 is also referred to as a candidate destination estimation means. In a case where the viewpoint P1 is at a building on the surrounding image for a predetermined time, the candidate destination estimation unit 109 acquires positions of a plurality of buildings including the building present in a predetermined range including the building from map information around the current position, and estimates the positions of the plurality of buildings as positions of candidate destinations. Note that the buildings include buildings built for the purpose of allowing people to spend time inside, buildings built for other purposes, and civil engineering structures.

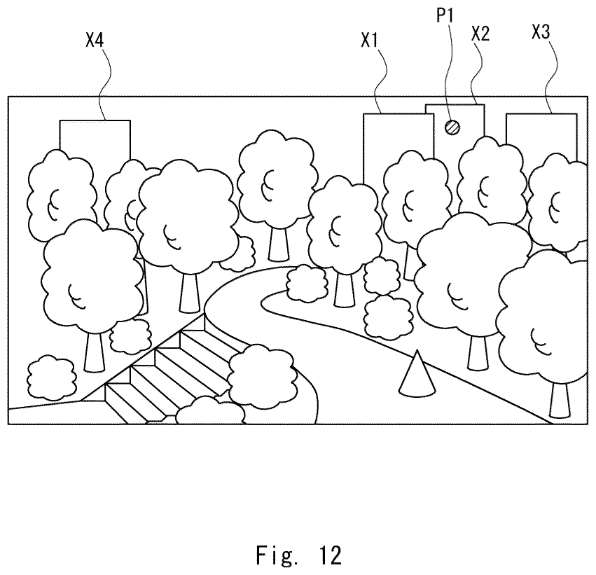

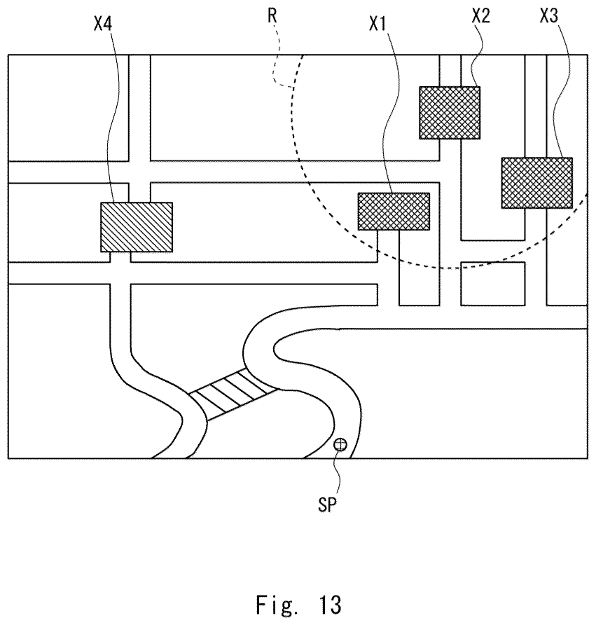

The estimation of the positions of the candidate destinations by the candidate destination estimation unit 109 will be described more specifically with reference to FIG. 12. In the surrounding image displayed on the display unit 102 illustrated in FIG. 12, there are a plurality of buildings X1 to X4 relatively far in front of the user U riding on the electric wheelchair W, and the viewpoint P1 of the user U is at the building X2. In this case, the candidate destination estimation unit 109 acquires positions (latitudes and longitudes) of a plurality of buildings X1 to X3 including the building X2 present in a predetermined range (e.g., a predetermined range with the building X2 as the center) including the building X2 from map information around the current position. For example, the candidate destination estimation unit 109 acquires a map around the current position SP as illustrated in FIG. 13, and acquires the positions (latitudes and longitudes) of the buildings X1 to X3 included in the predetermined range R including the building X2 on the map. The candidate destination estimation unit 109 sets the positions of the buildings X1 to X3 as positions of candidate destinations, and also acquires the names of the buildings X1 to X3 from the map. Note that the map can be acquired from a GPS system.

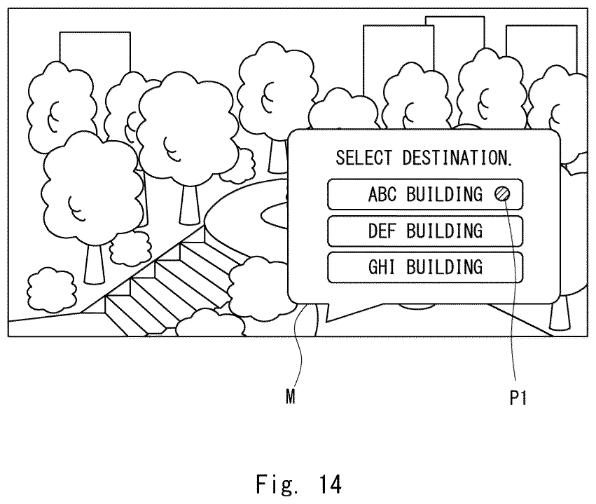

The selection reception unit 110 causes the display unit 102 to display a list of candidate destinations. Specifically, the selection reception unit 110 causes the display unit 102 to display the names of the buildings X1 to X3 estimated by the candidate destination estimation unit 109 in such a manner as to be superimposed on the surrounding image. For example, as illustrated in FIG. 14, the display unit 102 displays a message M “select a destination” with which the names of the buildings X1 to X3, “ABC building”, “DEF building”, and “GHI building”, are listed in a selectable manner and in a superimposed manner on the surrounding image. In addition, the user U can select a destination by looking at one of the names of the buildings X1 to X3 included in the message M, “ABC building”, “DEF building”, and “GHI building”. Then, for example, in a case where the viewpoint P1 is at the “ABC building”, among the names of the buildings X1 to X3 included in the message M, for the predetermined time, the selection reception unit 110 receives the selection of the building X1 as the destination.

The drive control unit 107C moves the electric wheelchair W to the destination (building X1) selected by the user U from the list of candidate destinations (buildings X1 to X3). Specifically, the drive control unit 107C determines a route from the current position SP to the building X1 as the destination based on a map around the current position SP as illustrated in FIG. 13, and moves the electric wheelchair W while automatically avoiding the obstacle I. Note that the stop mark B1, the emergency stop mark B2, and the like described in the second example embodiment may be displayed on the display unit 102. In a case where the viewpoint Pl of the user U is at the stop mark B1 or the emergency stop mark B2 for a predetermined time, the drive control unit 107C may stop or emergently stop the electric wheelchair W.

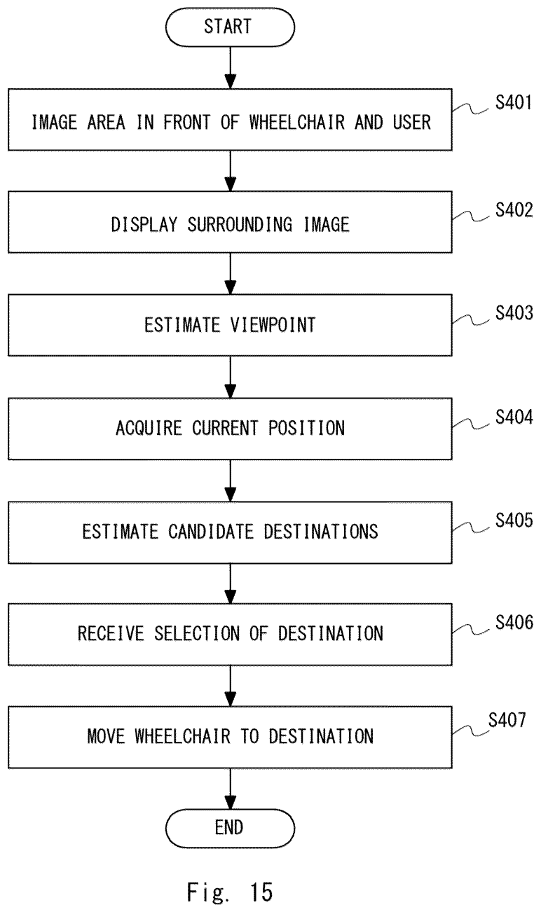

Next, a vehicle control method according to the fourth example embodiment will be described with reference to FIG. 15. Note that processing of steps S401 to S404 in the vehicle control method according to the fourth example embodiment is similar to the processing of steps S101 to S104 in the vehicle control method according to the first example embodiment, respectively, and thus description thereof will be omitted.

The candidate destination estimation unit 109 estimates the positions of the plurality of buildings X1 to X3 present in a predetermined range R including the building X2 as positions (latitudes and longitudes) of candidate destinations from the map information around the current position (step S406). In addition, the candidate destination estimation unit 109 acquires the names of the buildings X1 to X3 from the map, and outputs the names to the selection reception unit 110 together with the estimated positions (latitudes and longitudes).

The selection reception unit 110 causes the display unit 102 to display a list of candidate destinations (names of buildings X1 to X3), and receives selection of a candidate destination (building X1 in FIG. 14) at which the viewpoint P1 is present, among the candidate destinations, as a destination (step S407). In addition, the selection reception unit 110 outputs the position (latitude and longitude) of the destination (e. g., building X1) to the drive control unit 107C.

The drive control unit 107C moves the electric wheelchair W to the destination (building X1) (step S408), and ends this processing.

Note that the candidate destination estimation unit 109 may acquire other information regarding the candidate destinations together with or instead of the names of the candidate destinations. For example, the candidate destination estimation unit 109 may acquire images of the appearance and the inside of the buildings X1 to X3 as candidate destinations together with or instead of the names. Then, the selection reception unit 110 may cause the display unit 102 to display images of the exteriors and interiors of the buildings X1 to X3 as a list of candidate destinations.

In the vehicle control apparatus 100C according to the fourth example embodiment described above, a list of candidate destinations including a desired building can be displayed on the display unit 102 only by the user U looking at the direction of the desired building on the surrounding image, and the electric wheelchair W can be moved to the desired building only by the user U looking at the desired building in the list. As a result, even if a destination desired by the user U is relatively far away, the electric wheelchair W can be moved to the destination more easily and more reliably.

### Modified Example of Fourth Example Embodiment

Note that the vehicle control apparatus 100C may not include the candidate destination estimation unit 109 and the selection reception unit 110, and the destination estimation unit 106 may acquire a position of a building at which the viewpoint P1 of the user U is located on the surrounding image from a map around the current position, and estimate the position of the building as a position of a destination.

Note that, in the above-described example embodiments, the configuration of the hardware has been described, but the present disclosure is not limited thereto. According to the present disclosure, any processing can also be implemented by causing a processor to execute a computer program.

In the above-described example, the program may be stored using various types of non-transitory computer-readable media and supplied to a computer. The non-transitory computer-readable media include various types of tangible storage media. Examples of the non-transitory computer-readable media include a magnetic recording medium (e.g., a flexible disk, a magnetic tape, or a hard disk drive), a magneto-optical recording medium (e.g., a magneto-optical disc), a CD-read only memory (ROM), a CD-R, a CD-R/W, a digital versatile disc (DVD), and a semiconductor memory (e.g., a mask ROM, a programmable ROM (PROM), an erasable PROM (EPROM), a flash ROM, or a random access memory (RAM)). In addition, the program may be supplied to the computer by various types of transitory computer-readable media. Examples of the transitory computer-readable media include electrical signals, optical signals, and electromagnetic waves. The transitory computer-readable media can supply the programs to the computer via a wired communication path such as an electric wire or an optical fiber or a wireless communication path.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above-described example embodiments may be described as in the following supplementary notes, but are not limited to the following supplementary notes.

### Supplementary Note 1

A vehicle control apparatus including:

a first imaging means for imaging surroundings including at least an area in front of a vehicle;

a display means for displaying a surrounding image captured by the first imaging means;

a second imaging means for imaging at least a user riding on the vehicle;

a viewpoint estimation means for estimating a position of a viewpoint of the user on the surrounding image displayed on the display means based on the user image captured by the second imaging means;

a current position acquisition means for acquiring a current position of the vehicle;

a destination estimation means for estimating a position of a destination corresponding to the viewpoint based on at least the position of the viewpoint and the current position of the vehicle in a case where the viewpoint is at the same location on the surrounding image for a predetermined time; and

a drive control means for moving the vehicle to the position of the destination.

### Supplementary Note 2

The vehicle control apparatus according to supplementary note 1, in which the destination estimation means estimates the position of the destination corresponding to the viewpoint based on the position of the viewpoint, the current position of the vehicle, an angle of view and specifications of an imaging sensor included in the first imaging means, and a posture of the vehicle.

### Supplementary Note 3

The vehicle control apparatus according to supplementary note 1 or 2, in which

the display means displays a stop mark together with the surrounding image, and

the drive control means stops the vehicle in a case where the viewpoint is at the stop mark on the surrounding image for the predetermined time.

### Supplementary Note 4

The vehicle control apparatus according to any one of supplementary notes 1 to 3, further including a destination direction estimation means for estimating a destination direction corresponding to a line-of-sight direction of the user estimated based on the user image,

in which the drive control means moves the vehicle in the destination direction.

### Supplementary Note 5

The vehicle control apparatus according to any one of supplementary notes 1 to 4, in which the destination estimation means acquires a position of a building from map information around the current position, and estimates the position of the building as the position of the destination, in a case where the viewpoint is at the building on the surrounding image for the predetermined time.

### Supplementary Note 6

The vehicle control apparatus according to any one of supplementary notes 1 to 5, further including a candidate destination estimation means for acquiring, in a case where the viewpoint is at a building on the surrounding image for the predetermined time, positions of a plurality of buildings including the building present in a predetermined range including the building from map information around the current position, and estimating the positions of the plurality of buildings as positions of candidate destinations, in which the display means displays a list of the candidate destinations, and the drive control means moves the vehicle to the destination selected by the user from the list of the candidate destinations.

### Supplementary Note 7

A vehicle control method performed by a computer, the vehicle control method including:

causing a first imaging means to image surroundings including at least an area in front of a vehicle;

causing a display means to display a surrounding image captured by the first imaging means;

causing a second imaging means to image at least a user riding on the vehicle;

estimating a position of a viewpoint of the user on the surrounding image displayed on the display means based on the user image captured by the second imaging means;

acquiring a current position of the vehicle;

estimating a position of a destination corresponding to the viewpoint based on at least the position of the viewpoint and the current position of the vehicle in a case where the viewpoint is at the same location on the surrounding image for a predetermined time; and

moving the vehicle to the position of the destination.

### Supplementary Note 8

The vehicle control method according to supplementary note 7, in which the computer is configured to estimate the position of the destination corresponding to the viewpoint based on the position of the viewpoint, the current position of the vehicle, an angle of view and specifications of an imaging sensor included in the first imaging means, and a posture of the vehicle, in a case where the viewpoint is at the same location on the surrounding image for the predetermined time.

### Supplementary Note 9

The vehicle control method according to supplementary note 7 or 8, in which the computer is configured to:

cause the display means to display a stop mark together with the surrounding image; and

stop the vehicle in a case where the viewpoint is at the stop mark on the surrounding image for the predetermined time.

### Supplementary Note 10

The vehicle control method according to any one of supplementary notes 7 to 9, in which the computer is configured to:

estimate a line-of-sight direction of the user based on the user image;

estimate a destination direction corresponding to the line-of-sight direction; and

move the vehicle in the destination direction.

### Supplementary Note 10

The vehicle control method according to any one of supplementary notes 7 to 10, in which the computer is configured to acquire a position of a building from map information around the current position, and estimate the position of the building as the position of the destination, in a case where the viewpoint is at the building on the surrounding image for the predetermined time.

### Supplementary Note 12

The vehicle control method according to any one of supplementary notes 7 to 11, in which the computer is configured to:

in a case where the viewpoint is at a building on the surrounding image for the predetermined time, acquire positions of a plurality of buildings including the building present in a predetermined range including the building from map information around the current position, and estimate the positions of the plurality of buildings as positions of candidate destinations;

cause the display means to display a list of the candidate destinations; and

move the vehicle to the destination selected by the user from the list of the candidate destinations.

### Supplementary Note 13

A non-transitory computer-readable medium storing a program that causes a computer to execute:

causing a first imaging means to image surroundings including at least an area in front of a vehicle;

causing a display means to display a surrounding image captured by the first imaging means;

causing a second imaging means to image at least a user riding on the vehicle;

estimating a position of a viewpoint of the user on the surrounding image displayed on the display means based on the user image captured by the second imaging means;

acquiring a current position of the vehicle;

estimating a position of a destination corresponding to the viewpoint based on at least the position of the viewpoint and the current position of the vehicle in a case where the viewpoint is at the same location on the surrounding image for a predetermined time; and

moving the vehicle to the position of the destination. ps Supplementary Note 14

The non-transitory computer-readable medium according to supplementary note 13, in which the program causes the computer to execute estimating the position of the destination corresponding to the viewpoint based on at least the position of the viewpoint, the current position of the vehicle, an angle of view and specifications of an imaging sensor included in the first imaging means, and a posture of the vehicle, in a case where the viewpoint is at the same location on the surrounding image for the predetermined time.

### Supplementary Note 15

The non-transitory computer-readable medium according to supplementary note 13 or 14, in which the program causes the computer to execute:

causing the display means to display a stop mark together with the surrounding image; and

stopping the vehicle in a case where the viewpoint is at the stop mark on the surrounding image for the predetermined time.

### Supplementary Note 16

The non-transitory computer-readable medium according to any one of supplementary notes 13 to 15, in which the program causes the computer to execute:

estimating a line-of-sight direction of the user based on the user image;

estimating a destination direction corresponding to the line-of-sight direction; and

moving the vehicle in the destination direction.

### Supplementary Note 17

The non-transitory computer-readable medium according to any one of supplementary notes 13 to 16, in which the program causes the computer to execute acquiring a position of a building from map information around the current position, and estimating the position of the building as the position of the destination, in a case where the viewpoint is at the building on the surrounding image for the predetermined time.

### Supplementary Note 18

The non-transitory computer-readable medium according to any one of supplementary notes 13 to 17, in which the program causes the computer to execute:

in a case where the viewpoint is at a building on the surrounding image for the predetermined time, acquiring positions of a plurality of buildings including the building present in a predetermined range including the building from map information around the current position, and estimating the positions of the plurality of buildings as positions of candidate destinations;

causing the display means to display a list of the candidate destinations; and

moving the vehicle to the destination selected by the user from the list of the candidate destinations.

### REFERENCE SIGNS LIST

100, 100A, 100B, 100C VEHICLE CONTROL APPARATUS
101 FIRST IMAGING UNIT (FIRST IMAGING MEANS)
102, 102A DISPLAY UNIT (DISPLAY MEANS)
103 SECOND IMAGING UNIT (SECOND IMAGING MEANS)
104, 104A VIEWPOINT ESTIMATION UNIT (VIEWPOINT ESTIMATION MEANS)
105 CURRENT POSITION ACQUISITION UNIT (CURRENT POSITION ACQUISITION MEANS)
106 DESTINATION ESTIMATION UNIT (DESTINATION ESTIMATION MEANS)
107, 107A, 107B, 107C DRIVE CONTROL UNIT (DRIVE CONTROL MEANS)
108 DESTINATION DIRECTION ESTIMATION UNIT (DESTINATION DIRECTION ESTIMATION MEANS)
109 CANDIDATE DESTINATION ESTIMATION UNIT (CANDIDATE DESTINATION ESTIMATION MEANS)
110 SELECTION RECEPTION UNIT
W ELECTRIC WHEELCHAIR (VEHICLE)
U USER
I OBSTACLE
P1, P2, P3 VIEWPOINT
STOP MARK
X1, X2, X3, X4 BUILDING
R PREDETERMINED RANGE
M MESSAGE AMENDMENT TO CLAIMS

What is claimed is:

1. A vehicle control apparatus comprising:
a memory storing instructions; and
one or more processors configured to execute the instructions to:
cause a first imaging device to image surroundings including at least an area in front of a vehicle;
cause a display device to display a surrounding image captured by the first imaging means device;
cause a second imaging device to image at least a user riding on the vehicle;
estimate a position of a viewpoint of the user on the surrounding image displayed on the display device based on the user image captured by the second imaging device;
acquire a current position of the vehicle;
estimate a position of a destination corresponding to the viewpoint based on at least the position of the viewpoint and the current position of the vehicle in a case where the viewpoint is at the same location on the surrounding image for a predetermined time; and
move the vehicle to the position of the destination.

2. The vehicle control apparatus according to claim 1, wherein the one or more processors configured to execute the instructions to estimate the position of the destination corresponding to the viewpoint based on the position of the viewpoint, the current position of the vehicle, an angle of view and specifications of an imaging sensor included in the first imaging device, and a posture of the vehicle.

3. The vehicle control apparatus according to claim 1, wherein
the one or more processors configured to execute the instructions to:
cause the display device to display a stop mark together with the surrounding image; and
stop the vehicle in a case where the viewpoint is at the stop mark on the surrounding image for the predetermined time.

4. The vehicle control apparatus according to claim 1, the one or more processors configured to execute the instructions to:
estimate a destination direction corresponding to a line-of-sight direction of the user estimated based on the user image;
move the vehicle in the destination direction.

5. The vehicle control apparatus according to claim 1, wherein the one or more processors configured to execute the instructions to acquire a position of a building from map information around the current position, and estimates the position of the building as the position of the destination, in a case where the viewpoint is at the building on the surrounding image for the predetermined time.

6. The vehicle control apparatus according to claim 1, the one or more processors configured to execute the instructions to:
acquire, in a case where the viewpoint is at a building on the surrounding image for the predetermined time, positions of a plurality of buildings including the building present in a predetermined range including the building from map information around the current position, and estimating the positions of the plurality of buildings as positions of candidate destinations;
cause the display device to display a list of the candidate destination; and
move the vehicle to the destination selected by the user from the list of the candidate destinations.

7. A vehicle control method performed by a computer, the vehicle control method comprising:
causing a first imaging device to image surroundings including at least an area in front of a vehicle;
causing a display device to display a surrounding image captured by the first imaging device;
causing a second imaging device to image at least a user riding on the vehicle;
estimating a position of a viewpoint of the user on the surrounding image displayed on the display device based on the user image captured by the second imaging device;
acquiring a current position of the vehicle;
estimating a position of a destination corresponding to the viewpoint based on at least the position of the viewpoint and the current position of the vehicle in a case where the viewpoint is at the same location on the surrounding image for a predetermined time; and
moving the vehicle to the position of the destination.

8. The vehicle control method according to claim 7, wherein the computer is configured to estimate the position of the destination corresponding to the viewpoint based on the position of the viewpoint, the current position of the vehicle, an angle of view and specifications of an imaging sensor included in the first imaging device, and a posture of the vehicle, in a case where the viewpoint is at the same location on the surrounding image for the predetermined time.

9. The vehicle control method according to claim 7, wherein the computer is configured to:
cause the display device to display a stop mark together with the surrounding image; and
stop the vehicle in a case where the viewpoint is at the stop mark on the surrounding image for the predetermined time.

10. The vehicle control method according to claim 7, wherein the computer is configured to:
estimate a line-of-sight direction of the user based on the user image;
estimate a destination direction corresponding to the line-of-sight direction; and
move the vehicle in the destination direction.

11. The vehicle control method according to claim 7, wherein the computer is configured to acquire a position of a building from map information around the current position, and estimate the position of the building as the position of the destination, in a case where the viewpoint is at the building on the surrounding image for the predetermined time.

12. The vehicle control method according to claim 7, wherein the computer is configured to:
in a case where the viewpoint is at a building on the surrounding image for the predetermined time, acquire positions of a plurality of buildings including the building present in a predetermined range including the building from map information around the current position, and estimate the positions of the plurality of buildings as positions of candidate destinations;
cause the display device to display a list of the candidate destinations; and
move the vehicle to the destination selected by the user from the list of the candidate destinations.

13. A non-transitory computer-readable medium storing a program that causes a computer to execute:
causing a first imaging device to image surroundings including at least an area in front of a vehicle;
causing a display device to display a surrounding image captured by the first imaging device;
causing a second imaging device to image at least a user riding on the vehicle;
estimating a position of a viewpoint of the user on the surrounding image displayed on the display device based on the user image captured by the second imaging device;
acquiring a current position of the vehicle;
estimating a position of a destination corresponding to the viewpoint based on at least the position of the viewpoint and the current position of the vehicle in a case where the viewpoint is at the same location on the surrounding image for a predetermined time; and
moving the vehicle to the position of the destination.

14. The non-transitory computer-readable medium according to claim 13, wherein the program causes the computer to estimate the position of the destination corresponding to the viewpoint based on at least the position of the viewpoint, the current position of the vehicle, an angle of view and specifications of an imaging sensor included in the first imaging device, and a posture of the vehicle, in a case where the viewpoint is at the same location on the surrounding image for the predetermined time.

15. The non-transitory computer-readable medium according to claim 13, wherein the program causes the computer to execute:
causing the display device to display a stop mark together with the surrounding image; and
stopping the vehicle in a case where the viewpoint is at the stop mark on the surrounding image for the predetermined time.

16. The non-transitory computer-readable medium according to claim 13, wherein the program causes the computer to execute:
estimating a line-of-sight direction of the user based on the user image;
estimating a destination direction corresponding to the line-of-sight direction; and
moving the vehicle in the destination direction.

17. The non-transitory computer-readable medium according to claim 13, wherein the program causes the computer to execute acquiring a position of a building from map information around the current position, and estimating the position of the building as the position of the destination, in a case where the viewpoint is at the building on the surrounding image for the predetermined time.

18. The non-transitory computer-readable medium according to claim 13, wherein the program causes the computer to execute:
in a case where the viewpoint is at a building on the surrounding image for the predetermined time, acquiring positions of a plurality of buildings including the building present in a predetermined range including the building from map information around the current position, and estimating the positions of the plurality of buildings as positions of candidate destinations;
causing the display device to display a list of the candidate destinations; and
moving the vehicle to the destination selected by the user from the list of the candidate destinations.
